(19) United States
(12) Patent Application Publication
(10) Pub. No.: US 2013/0110294 A1
(43) Pub. Date: May 2, 2013

(54) METHOD FOR OPERATING AN ENERGY AUTOMATION SYSTEM AND ENERGY AUTOMATION SYSTEM

(71) Applicant: Oleksandr Pochayevets, Nurnberg (DE)

(72) Inventor: Oleksandr Pochayevets, Nurnberg (DE)

(73) Assignee: SIEMENS AKTIENGESELLSCHAFT, MUENCHEN (DE)

(21) Appl. No.: 13/579,090

(22) PCT Filed: Feb. 15, 2010
(86) PCT No.: PCT/EP2010/051854

§ 371 Date: Sep. 17, 2012

(51) Int. Cl. G06F 1/26

(52) U.S. Cl. CPC G06F 1/26
USPC 700/286

(57) ABSTRACT

In an energy automation system for an electrical energy supply network, a local data processing device executes a program with functions for controlling and/or monitoring the energy supply network. The processing device is connected to a plurality of automation devices and to at least one remote data storage device, in which at least one program component for the program is stored. The start phase of the program is shortened by using a copy of the program component stored locally. When the program execution starts, the local data processing device checks if the copy of the local program component matches the current program component stored in the remote data storage device. The local data processing device executes the program with the copy of the program component if there is a match. Otherwise, it retrieves the program component from the remote memory and executes the program using the retrieved program component.

The invention relates to a method for operating an energy automation system which is set up to control and/or monitor an electrical energy supply network, the energy automation system having a local data processing device comprising at least one program which, during its execution, provides functions for controlling and/or monitoring the energy supply network, the local data processing device being connected, via first communication means, to a plurality of automation devices which are set up to acquire operating data which describe an operating state of the energy supply network and/or to generate and/or transmit control data suitable for controlling the energy supply network, and the local data processing device being connected, via second communication means, to at least one remote data memory which stores at least one program component which is needed to execute the at least one program.

Corresponding energy automation systems are offered by the applicant, for example under the product name “Spectrum Power CC”. These are software and hardware components for use in power system control centers for controlling and/or monitoring electrical energy supply networks. A known energy automation system has at least one local data processing device which provides a user with functions for controlling and/or monitoring the electrical energy supply network while executing one or more data processing programs (“programs” below). For this purpose, corresponding input means (for example mouse, keyboard, touch-sensitive screens) can be used to receive user inputs via the local data processing device, while suitable output means, for example displays, monitors or projection screens, are used to convey information relating to the state of the electrical energy supply network to the user. In this case, the programs in question executed by the local data processing device are used, for example, to make settings and carry out configurations, to carry out simulations and/or make predictions and to evaluate instantaneous or past operating states of the electrical energy supply network. In addition, up-to-date variables (for example current and voltage profiles) which characterize the operating state of the electrical energy supply network are displayed for operational management. The user can also perform control actions for influencing primary components of the electrical energy supply network. In addition to these functions which are cited only by way of example, any desired other control and/or monitoring functions may also be provided by the programs.

An energy automation system usually does not consist of a single data processing device but rather of a plurality of components which are connected to one another and may be, for example, locally and remotely arranged data processing devices and data memories. Whereas the local data processing devices and data memories are arranged in the immediate vicinity of one another, occasionally even in the same housing, larger spatial distances may often exist between local and remote data processing devices and data memories; this applies, for example, when the remote data processing devices and data memories are arranged in spatially remote control centers, switching stations or computing centers.

It may often be the case that program components which are stored in spatially remote data memories are needed to execute a program on a local data processing device of the energy automation system. Such program components may be, for example, library files, instantaneous and stored measured value profiles, data archives of measured values, control inputs and/or issued messages which occasionally comprise large volumes of data. In order to start a program on the local data processing device, it has hitherto been necessary to first of all transmit all program components held in the remote data memories from the remote data memories to the local data processing device via the second communication means and to load said components there into a main memory of the local data processing device, for example, during the starting phase of the program in order to execute the program using the program components. In particular, the operation of transmitting the individual program components to the local data processing device can take a comparatively long time in this case and may thus considerably delay the operation of starting the program.

Therefore, the invention is based on the object of specifying a method for operating an energy automation system of the type mentioned at the outset, in which the duration of the starting phase of a program on the local data processing device can be shortened. The intention is likewise to specify a corresponding energy automation system.

In order to achieve the object with respect to the method, the invention proposes a method of the type stated above, in which a copy of the at least one program component needed to execute the at least one program is held in a local data memory associated with the local data processing device, the local data processing device, when starting the execution of the at least one program, checks whether the copy of the at least one program component in the local data memory matches the program component stored in the remote data memory, the data processing device executing the at least one program using the at least one copy of the program component if there is a match and retrieving the at least one program component from the at least one remote data memory and executing the at least one program using the retrieved at least one program component if there is no match.

The invention is first of all based on the knowledge that the starting phase of a program on the local data processing device can be considerably shortened if the respective required program component is present in a local data memory which is associated with the local data processing device and is in the spatial vicinity of the local data processing device or is even integrated in the housing of the latter. This is because this makes it possible to dispense with the transmission of the at least one program component to the local data processing device, which transmission is responsible, in particular, for extending the starting phase. For this purpose, the local data memory holds copies of the respective required program components which are available to the local data processing device in a comparatively short time in order to start the execution of a program.

However, locally holding copies of all required program components alone does not suffice to ensure proper operation of the energy automation system. Rather, it must be ensured that the local copies of the individual program components also match their originals, that is to say the program components in question in the remote data memories, at the time at which the program is started. For this purpose, the local data processing device checks whether the local copy of the respective required program component matches the corresponding program component and executes the program using the local copy of the at least one program component if a match has been determined. In this case, an accordingly accelerated program start can thus be carried out. If there is no match, the at least one original program component must be downloaded from the at least one remote data memory in order to ensure proper operation. Therefore, in the last-mentioned case, an accordingly extended starting phase must be accepted in favor of proper execution of the program.

In order to check whether the copy of the at least one program component in the local data memory matches the at least one program component stored in the remote data memory, one advantageous embodiment of the method according to the invention provides for the local data processing device to determine a first identifying parameter which is suitable for identifying the copy of the at least one program component in the local data memory and to retrieve, from the at least one remote data memory, a second identifying parameter which is suitable for identifying the at least one program component stored in the at least one remote data memory, and for the local data processing device to compare the two identifying parameters with one another.

This makes it possible for the check for a match to take place in a comparatively simple manner and with a low volume of data to be transmitted since only the respective second identifying parameter for the at least one program component must be transmitted between the at least one remote data memory and the local data processing device.

In this context, provision may be specifically made, for example, for time stamps which indicate the time of the respective last change of the relevant at least one program component to be used as first and second identifying parameters.

Alternatively, provision may also be made for hash values which have been generated from the relevant copy of the at least one program component and from the relevant at least one program component using a hash function to be used as first and second identifying parameters.

An identifying parameter for the respective copy of the program component and the respective program component can be formed in a comparatively simple manner by using time stamps or hash values. Such an identifying parameter makes it possible, on the one hand, to readily identify the respective program component and the respective copy of the program component and, on the other hand, comprises a low volume of data for the purpose of fast data transmission.

If there is no match, another advantageous embodiment of the method according to the invention provides for the local data processing device to replace the copy of the at least one program component in the local data memory with the retrieved at least one program component with the formation of a new copy of the at least one program component.

In this case, if a discrepancy between the respective copy of the program component and the corresponding program component is detected, the retrieved program component is efficiently immediately stored as a new copy of the program component in the local data memory, with the result that recourse can be directly had to the updated copy of the program component when the execution of the program on the local data processing device is next started. On account of the updating carried out in this manner, the local copy matches the original program component in the remote data memory with a comparatively high degree of probability.

Another advantageous embodiment of the method according to the invention also provides for the local data processing device, when starting the execution of the at least one program, to first of all check whether there is actually a copy of the at least one program component in the local data memory, and, if there is no copy of the at least one program component, for the local data processing device to immediately retrieve the at least one program component from the at least one remote data memory.

This check makes it possible to determine, in a quasi anticipatory manner, whether it is actually useful to check the local copy of the at least one program component for up-to-dateness since it goes without saying that this check is superfluous if there is actually no copy of the program component in the local data memory (for example when the program is started for the first time). In such a case, a check for a match can then be dispensed with and the relevant program component can be immediately downloaded from the remote data memory.

Another advantageous embodiment of the method according to the invention provides for the local data processing device to check, at least once during the execution of the program, whether the copy of the at least one program component in the local data memory still matches the at least one program component stored in the at least one remote data memory and, if there is no match, to retrieve the at least one program component from the at least one remote data memory and to replace the copy of the at least one program component in the local data memory with the retrieved at least one program component with the formation of a new copy of the at least one program component.

This makes it possible to ensure, in particular during more prolonged execution of the program or in the case of frequently changing program components, that an up-to-date copy of the relevant program component is present in the local data memory with a comparatively high degree of probability the next time the program is started. This is because this makes it possible to already update the copy of the program component in the local data memory in an anticipatory manner for the next starting phase in the background during execution of the program. For example, the local copy of the at least one program component can be updated at regular intervals during execution of the program or when the program is ended.

Another advantageous embodiment of the method according to the invention provides for a plurality of program components which are stored in the at least one remote data memory to be needed to execute the at least one program, and for the local data memory to comprise a corresponding number of copies of the plurality of program components, for the local data processing device to check all copies of the program components and all program components for a match, and, if there is no match for at least one program component, to retrieve all program components from the at least one remote data memory.

This ensures that, if only a single program component differs, all required program components are always downloaded from the at least one remote data memory in each case. In this case, the effort needed to check for a match between the respective program component and the present copy of the program component is reduced, in particular, since the check can already be terminated when the first discrepancy is detected and all program components are downloaded from the at least one remote data memory.

Alternatively, provision can also be made for a plurality of program components which are stored in the at least one remote data memory to be needed to execute the at least one program, and for the local data memory to comprise a corresponding number of copies of the plurality of program components, for the local data processing device to check all copies of the program components and all program components for a match, and, if there is no match, to retrieve the respective relevant program component from the at least one remote data memory.

In this embodiment, only that program component for which a discrepancy from the copy of the program component in question in the local data memory has been determined is respectively downloaded from the at least one remote data memory. In other words, only those local copies of the program components which are actually no longer up-to-date are replaced with the up-to-date program components. The respective up-to-date copies of the program components are then used to execute the program, while the original program components are downloaded instead of the copies which are no longer up-to-date.

Use of the last-mentioned exemplary embodiment is suitable, in particular, for program components having a comparatively large volume of data since only the actually required program components have to be actually transmitted via the second communication means in this case.

With regard to the energy automation system, the above-mentioned object is also achieved by means of an energy automation system for controlling and/or monitoring an electrical energy supply network, having a local data processing device which comprises at least one program which, during its execution, provides functions for controlling and/or monitoring the energy supply network, first communication means which are used to connect the local data processing device to a plurality of automation devices which are set up to acquire operating data which describe an operating state of the energy supply network and/or to generate and/or transmit control data suitable for controlling the energy supply network, and second communication means which are used to connect the local data processing device to at least one remote data memory which stores at least one program component which is needed to execute the at least one program.

The invention provides for the energy automation system to be set up to carry out a method as claimed in one of claims 1 to 9.

One advantageous embodiment of the energy automation system according to the invention provides for the first and second communication means to be communication means which are physically different from one another.

In this case, the first communication means may be, for example, in the form of a data transmission bus for station control technology or power system control technology, and the second communication means may be formed by a communication network which connects individual switching stations or power system control rooms to one another.

Alternatively, provision can also be made for the first and second communication means to be formed by a common physical communication means.

In this case, communication between the local data processing device and the automation devices, on the one hand, and between the local data processing device and the at least one remote data memory, on the other hand, takes place via the same physical communication device.

The energy automation system may be specifically arranged, for example, in a switching station or a power system control center of the energy supply network.

The invention is explained in more detail below using exemplary embodiments. In this respect, in the drawings:

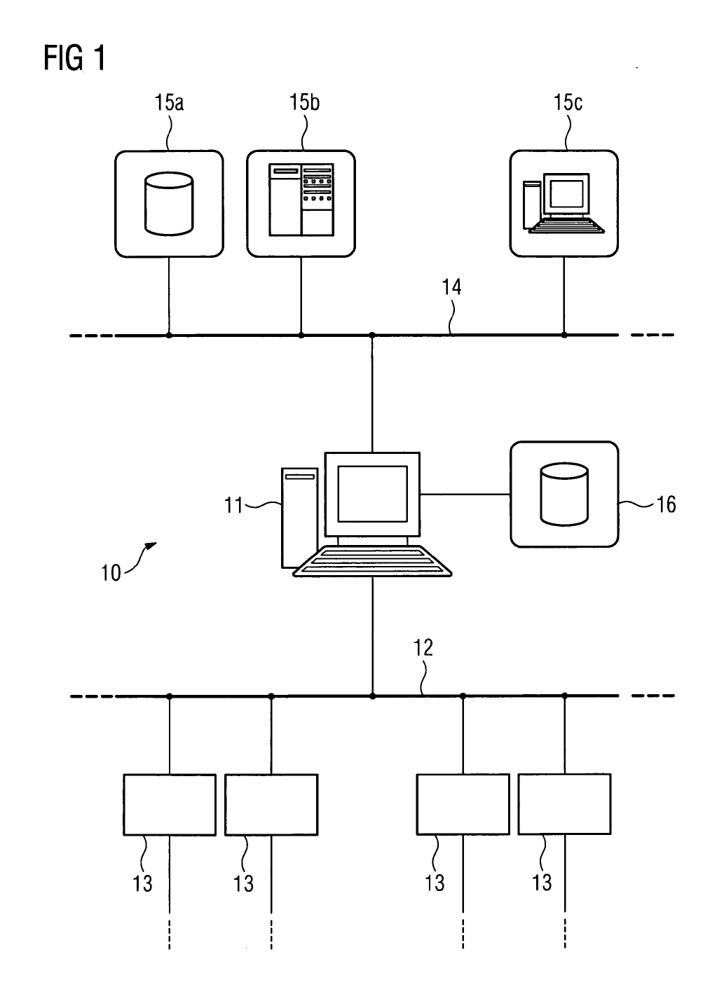

FIG. 1 shows a schematic block diagram of an energy automation system; and

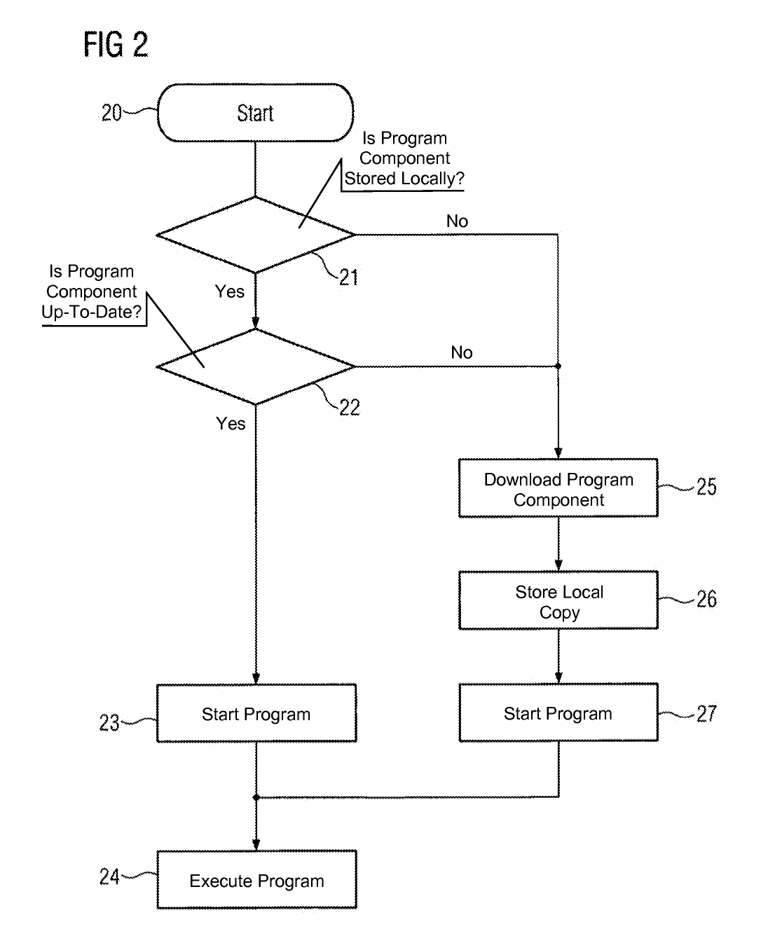

FIG. 2 shows a schematic method flowchart for explaining the procedure when starting the execution of a program on the local data processing device.

FIG. 1 shows an energy automation system 10 for controlling and/or monitoring an electrical energy supply network (not shown in FIG. 1). The energy automation system has a local data processing device 11 which may be, for example, a conventional personal computer or a data processing device specially adapted to the requirements of a switching station or a power system control station. The local data processing device 11 is connected, on the one hand, to automation devices 13 via first communication means 12 and is connected, on the other hand, to remote data memories 15a, 15b, 15c via second communication means 14.

As indicated with dashed lines in FIG. 1, the automation devices 13 are directly or indirectly connected to primary components of the electrical energy supply network which may be, for example, lines, cables, transformers, switches, generators, motors or converters of the energy supply network. The individual automation devices 13 are set up to acquire operating data (for example measured values of current, voltage, frequency, temperature and/or values derived therefrom as well as automatically generated messages or alarms) which describe an operating state of the energy supply network and/or to generate and/or transmit control data (for example control instructions, commands and parameterization data generated automatically or by a user input) suitable for controlling the energy supply network. Specifically, the automation devices 13 may be, for example, control devices for controlling primary components of the energy supply network, “remote terminal units” (RTUs) for recording measured values, measuring devices, “merging units” for combining measured values from individual measuring devices or RTUs, phasor measuring devices (“phasor measurement units”—PMUs) or protective devices. The automation devices 13 are arranged either inside a control room or switching station or directly on the primary components of the electrical energy supply network.

The first communication means 12, which are used for the data connection between the local data processing device 11 and the automation devices 13, and the second communication means 14, which are intended to transmit data between the local data processing device 11 and the remote data memories 15a, 15b, 15c, may be, for example, hard-wired point-to-point connections, a communication bus or a communication network in which data are transmitted according to any desired communication protocols and communication technologies. The communication connections may be in the form of fiber-optic cables or copper lines, for example. Data can be transmitted, for example, via an IP network, a telecommunication connection or a so-called power-line communication connection. In this case, wired or wireless data transmission technologies are possible. For example, operating and control data can be transmitted via the first communication means 12 in the form of data messages which are formed according to the IEC 61850 standard which relates to communication in switchgear.

The remote data memories 15a, 15b, 15c may be arranged, for example, in remote switchgear, power system control rooms or computing centers. The remote data memories 15 may be any desired data storage devices. Only by way of example, FIG. 1 illustrates the remote data memory 15a as a remotely readable data memory (for example in the form of a so-called “network hard disk” which is also referred to as “network attached storage” (NAS)), illustrates the remote data memory 15b as a server device and illustrates the remote data memory 15c as a data memory (for example a hard disk) which is integrated in a remote data processing device.

The local data processing device 11 is also connected to a local data memory 16 which may be arranged either in the housing of the local data processing device 11 (for example as an internal hard disk) or is located at least in the immediate vicinity of the local data processing device 11 and is connected to the latter via a data connection with a high data transmission capacity.

The local data processing device 11 provides at least one program which, during its execution, performs functions for controlling and/or monitoring the energy supply network. These functions may be performed automatically or under the control of a user.

The program provided by the local data processing device 11 may be, for example, those programs which are suitable for displaying up-to-date variables (for example current and voltage profiles) which characterize the operating state of the electrical energy supply network to a user for operational management and/or for implementing control actions for influencing primary components of the electrical energy supply network, which actions are triggered automatically or by the user. Furthermore, such programs may make it possible, for example, for a user to make settings and carry out configurations, for example with respect to the primary components of the energy supply network or the automation devices 13, to carry out simulations of fictitious operating states and/or to make predictions of future operating states of the energy supply network and to evaluate instantaneous or past operating states of the energy supply network. In addition to these functions which are cited only by way of example, the programs may also provide any desired further control and/or monitoring functions.

In order to carry out the program, the local data processing device requires individual program components, at least one of which is stored in one of the remote data memories 15a, 15b, 15c. This is because, in a distributed computer network, as is often used for energy automation systems, it is not rare for individual required program components to be held in remote data memories. Such program components may be, for example, library files, profiles of instantaneous and past measured values, files of a weather database, files of expert databases and data archives containing measured values, control inputs and/or issued messages which occasionally comprise large volumes of data.

With the addition of FIG. 2, the text below is intended to describe a method which, despite the presence of individual program components in the remote data memories 15a, 15b, 15c, can be used to substantially accelerate the start of the execution of the program on the local data processing device 11.

In this respect, FIG. 2 shows, in a schematic method flowchart, the individual steps which are carried out when starting the execution of a program on the local data processing device 11. For the purpose of simplification, it shall first of all be assumed that only one program component which is in the remote data memory 15b, for example, is needed to start the program in question. However, the procedure described below can also be applied to a plurality of program components stored in one or more remote data memories.

First of all, the start of the program in question on the local data processing device 11 is triggered in a step 20. This may be effected, for example, by means of a user input or may be triggered by means of an automatic program call from a further program which has already been executed by the local data processing device 11. The program component which is stored in the remote data memory 15b is needed to execute the program.

In a first checking step 21, the local data processing device 11 checks whether a copy of the program component in question is held in the local data memory 16. If this is the case, there follows a further checking step 22, according to which the local data processing device 11 checks whether the copy of the program component in question is an up-to-date version or whether the copy has aged in the meantime as a result of changes to the original program component in the external data memory 15b. In order to carry out the check according to step 22, the local data processing device 11 compares the copy of the program component in question in the local data memory 16 with the original program component in the external data memory 15b using suitable criteria.

Specifically, for the purpose of this check, provision may be made, for example, for the local data processing device 11 to form a first identifying parameter which is suitable for identifying the copy of the program component in question in the local data memory 16. A second identifying parameter which is suitable for identifying the relevant program component stored in the remote data memory 15b is determined in a corresponding manner. The second identifying parameter is transmitted to the local data processing device 11.

In this case, the second identifying parameter for the program component in question may be formed, for example, while storing the program component in the remote data memory 15b and may be additionally stored in the remote data memory 15b in order to be available to the local data processing device 11 for retrieval. If the remote data memory 15b itself has a computation unit (for example a microprocessor), it is alternatively also possible for the identifying parameter for the program component to be determined by the remote data memory 15 itself in response to a request triggered by the local data processing device 11 and to be transmitted to the local data processing device 11 via the second communication means 14.

Time stamps which indicate the time of the last change of the program component may be used, for example, as first and second identifying parameters which are suitable for identifying the program component and the copy of the program component. The important factor for comparability in this case is that the time stamp for the last change of the program component (and not of the copy) is also stored in connection with the copy of the program component. Comparing the time stamp of the copy of the program component (first identifying parameter) with the time stamp of the program component (second identifying parameter) makes it possible to check whether both time stamps match.

If a match is detected, it can be concluded therefrom that the original program component in the remote data memory 15b has no longer been changed since the creation of the copy of the program component in the local data memory 16 and the copy of the program component is thus up-to-date.

If no match is detected, that is to say the time stamp of the original program component in the remote data memory 15b gives a different—usually a more recent—time than the time stamp of the copy of the program component held in the local data memory 16, it is possible to infer a copy of the program component which has aged in the meantime in the local data memory 16.

A further suitable possible way of determining an identifying parameter is to form a “hash value” (alternatively also referred to as “hash code”) of the copy of the program component as a first identifying parameter using a so-called “hash function” and to form a hash value of the program component as a second identifying parameter. When using a hash function, a comparatively large volume of data is usually mapped by the hash value which comprises a considerably lower volume of data. Both hash values are compared with one another by the local data processing device 11. If the check by the local data processing device 11 reveals that the hash values of the program component and of the copy of the program component match, the copy of the program component is up-to-date. If there is no match, the copy of the program component has accordingly aged.

The use of the identifying parameters—for example in the form of a time stamp or a hash value—entails the advantage, in particular, that, in order to check whether the copy of the program component in the local data memory 16 is up-to-date, it is necessary to only transmit comparatively low volumes of data between the local data processing device 11 and the remote data memory 15b. As a result, the check can be carried out in a comparatively fast manner.

If the check carried out in the checking step 22 reveals that the local copy of the program component is up-to-date (“yes” output), the continued start of the execution of the program on the local data processing device 11 is carried out according to a subsequent step 23 using the local copy of the program component. Using the copy of the program component in the local data memory 16 makes it possible to considerably shorten the starting phase between the triggering of the start of the program and the proper execution of the program because the required program component need not be first retrieved from the remote data memory 15b. In particular, if only a comparatively slow communication connection is possible via the second communication means 14 or the program component in question comprises a large volume of data, as may occur, for example, in the case of stored measured value profiles, the starting phase is considerably shortened by using the local copy of the program component.

The called program is finally properly executed by the local data processing device 11 in step 24.

In contrast, if the check in the checking step 22 reveals that the copy of the program component in the local data memory 16 is not up-to-date, for example because the respective identifying parameters of the program component and of the copy of the program component do not match, the local data processing device 11 retrieves the required program component from the remote data memory 15b in a downloading step 25. For this purpose, the program component in question must be transmitted between the remote data memory 15b and the local data processing device 11 via the second communication means 14.

In a subsequent step 26, the program component retrieved from the remote data memory 15b is stored in the local data memory 16 instead of the (aged) copy of the program component with the formation of an accordingly updated new copy of the program component.

According to a subsequent step 27, the requested program is started by the local data processing device 11 using the program component retrieved from the remote data memory 15b and is finally properly executed in step 24.

If the check carried out in the checking step 21 reveals that there is actually no copy of the program component in question in the local data memory 16, for example because the desired program is executed for the first time by the local data processing device 11 and therefore the required program component has never been transmitted to the local data processing device 11, the subsequent checking step 22 is skipped and the retrieval of the program component in question from the remote data memory 15b is immediately started in step 25. This makes it possible to circumvent a check which is unnecessary in that case in the checking step 22.

The steps 21 (checking whether there is actually a local copy of the program component) and 26 (replacing the local copy with the retrieved program component) illustrated in FIG. 2 are not absolutely necessary for carrying out the described method and can therefore also be optionally omitted. However, they contribute to further acceleration of the described method.

Furthermore, provision may optionally be made for a check to be carried out as well, at least once during the proper execution of the program on the local data processing device 11, in order to determine whether the copy of the program component in the local data memory 16 still matches the original program component in the remote data memory 15b and, if a discrepancy is detected, for the original program component to be retrieved from the remote data memory 15b in the background and for the (aged) copy of the program component in the local data memory 16 to be replaced with the retrieved program component. This optional embodiment considerably increases the probability of there being an up-to-date copy of the program component in the local data memory 16 when the program is next started on the local data processing device 11 and of the starting phase of the program being able to be carried out in shortened form by using this up-to-date copy of the program component. This optional procedure described last is not illustrated in FIG. 2 for the sake of clarity. However, the check can take place in a manner corresponding to the check carried out in the checking step 22, with the result that reference is made to the statements made with respect to the checking step 22 for a more detailed explanation.

For the sake of simplicity, the previous statements were restricted to the fact that only a single program component in the remote data memory 15b is needed to start the execution of the program. However, a plurality of program components, at least some of which are held in one or more of the remote data memories 15a, 15b, 15c, are usually needed to execute a program.

In this case, a first embodiment may provide for the method described in FIG. 2 to be carried out for each required program component and, if a discrepancy with regard to only a single program component is determined, for all program components—irrespective of whether or not the further copies are in an up-to-date form—to be retrieved from the respective remote data memory 15a, 15b, 15c. In other words, as soon as only a single copy of a program component is identified as not being up-to-date because it differs from the original program component in the corresponding remote data memory 15a, 15b, 15c, all required program components are downloaded from their corresponding remote data memories 15a, 15b, 15c. This variant is particularly suitable when a very large number of smaller program components are needed to execute the program and consequently the check according to checking step 22 would make up a comparatively large proportion of time of the starting phase of the program, while the transmission of the required program components from the respective remote data memory 15a, 15b, 15c to the local data processing device 11 would take comparatively little time on account of the low volumes of data. The prematurely terminated check according to step 22 in this embodiment thus makes it possible to circumvent a time-consuming check for up-to-dateness.

However, as an alternative to this, a second variant may also provide for a check to be individually carried out for each program component in order to determine whether the copy of the program component in the local data memory 16 is up-to-date, and for only those program components for which the check revealed a discrepancy to be actually downloaded. This embodiment is particularly suitable in the case of few required program components with comparatively large volumes of data since the period of time for the check according to checking step 22 would only make up a comparatively small proportion of the starting phase in this case, while the transmission of each individual program component from the respective remote data memory 15a, 15b, 15c to the local data processing device 11 would be a comparatively large proportion of time of the starting phase. In this case, the starting phase can be kept comparatively short by transmitting only the actually required program components from the respective remote data memory 15a, 15b, 15c to the local data processing device 11 and additionally using the up-to-date copies of program components in the local data memory 16.

The described method, in all its embodiments, ensures, on the one hand, that, if there is an up-to-date copy of the program component in the local data memory 16, this local copy of the program component is used to start the execution of the program in a faster manner. On the other hand, it is ensured that the up-to-date program component is always used to execute the program since, if a discrepancy is detected between the copy of the program component and the program component, recourse is had to the original program component in the remote data memory 15a, 15b, 15c. Proper execution of the desired program using the respective up-to-date program component is thus ensured in any case.

1-13. (canceled)

14. A method of operating an energy automation system that is configured to control and/or monitor an electrical energy supply network,
the energy automation system having a local data processing device providing at least one program which, during an execution thereof, provides functions for controlling and/or monitoring the energy supply network;
the local data processing device being connected, via first communication means, to a plurality of automation devices that are configured to acquire operating data describing an operating state of the energy supply network and/or to generate and/or transmit control data suitable for controlling the energy supply network; and
the local data processing device being connected, via second communication means, to at least one remote data memory having stored thereon at least one program component required to execute the at least one program;
the method which comprises:
storing a copy of the at least one program component required to execute the at least one program in a local data memory associated with the local data processing device;
when an execution of the at least one program is started, checking with the local data processing device whether the copy of the at least one program component in the local data memory matches the program component stored in the remote data memory;
if there is a match between the program component in the local data memory and the program component stored in the remote data memory, executing the at least one program in the local data processing device using the at least one copy of the program component; and
if there is no match, retrieving the at least one program component from the at least one remote data memory and executing the at least one program using the retrieved at least one program component.

15. The method according to claim 14, wherein the checking step comprises determining with the local data processing device a first identifying parameter which is suitable for identifying the copy of the at least one program component in the local data memory and retrieving from the at least one remote data memory a second identifying parameter which is suitable for identifying the at least one program component stored in the at least one remote data memory; and comparing the first and second identifying parameters with one another with the local data processing device.

16. The method according to claim 15, which comprises using time stamps that indicate a time of a respective last change of the relevant at least one program component as the first and second identifying parameters.

17. The method according to claim 15, which comprises using hash values that have been generated from the relevant copy of the at least one program component and from the relevant at least one program component using a hash function as first and second identifying parameters.

18. The method according to claim 14, which comprises, if there is no match, replacing with the local data processing device the copy of the at least one program component in the local data memory with the retrieved at least one program component and thereby forming of a new copy of the at least one program component.

19. The method according to claim 14, wherein the local data processing device, when starting the execution of the at least one program, first of all checks whether there is actually a copy of the at least one program component in the local data memory, and, if there is no copy of the at least one program component, immediately retrieving with the local data processing device the at least one program component from the at least one remote data memory.

20. The method according to claim 14, which comprises checking, with the local data processing device, at least once during the execution of the program, whether the copy of the at least one program component in the local data memory still matches the at least one program component stored in the at least one remote data memory and, if there is no match, retrieving the at least one program component from the at least one remote data memory and replacing the copy of the at least one program component in the local data memory with the retrieved at least one program component and thereby forming of a new copy of the at least one program component.

21. The method according to claim 14, wherein a plurality of program components which are stored in the at least one remote data memory are needed to execute the at least one program, and the local data memory comprises a corresponding number of copies of the plurality of program components, and the method further comprises:
checking with the local data processing device all copies of the program components and all program components for a match; and
if there is no match for at least one program component, retrieving with the local data processing device all program components from the at least one remote data memory.

22. The method according to claim 14, wherein a plurality of program components which are stored in the at least one remote data memory are needed to execute the at least one program, and the local data memory comprises a corresponding number of copies of the plurality of program components, and the method further comprises:
checking with the local data processing device all copies of the program components and all program components for a match; and
if there is no match, retrieving with the local data processing device the respective relevant program component from the at least one remote data memory.

23. An energy automation system for controlling and/or monitoring an electrical energy supply network, the system comprising:
a local data processing device configured to provide at least one program which, during an execution thereof, provides functions for controlling and/or monitoring the energy supply network;
a first communication device configured to connect said local data processing device to a plurality of automation devices that are set up to acquire operating data describing an operating state of the energy supply network and/or to generate and/or transmit control data suitable for controlling the energy supply network; and
a second communication device configured to connect said local data processing device to at least one remote data memory storing at least one program component needed to execute the at least one program;
the energy automation system being configured to carry out the method according to claim 14.

24. The energy automation system according to claim 23, wherein said first and second communication devices are communication means that are physically different from one another.

25. The energy automation system according to claim 23, wherein said first and second communication devices are formed by a common physical communication means.

26. The energy automation system according to claim 23, wherein said energy automation system is disposed in a switching station of the energy supply network or a power system control center of the energy supply network.
